(19) United States
(12) Patent Application Publication
(10) Pub. No.: US 2014/0109221 A1
(43) Pub. Date: Apr. 17, 2014

(54) USER DEVICE, METHOD OF USING FUNCTION LOCK OF THE SAME AND COMPUTER-READABLE RECORDING MEDIUM

(71) Applicants: CRUCIALSOFT COMPANY, Seoul (KR); CRUCIALTEC CO.,LTD., Chungcheongnam-do (KR)

(72) Inventors: Jong Chul SEO, Gyeonggi-do (KR); Hyo Min JOO, Gyeonggi-do (KR)

(73) Assignees: CRUCIALSOFT COMPANY, Seoul (KR); CRUCIALTEC CO.,LTD., Chungcheongnam-do (KR)

(21) Appl. No.: 14/045,938

(22) Filed: Oct. 4, 2013

(30) Foreign Application Priority Data
Oct. 4, 2012 (KR) 10-2012-0110164

(51) Int. Cl. G06F 21/32

(52) U.S. Cl. CPC G06F 21/32
USPC 726/19

(57) ABSTRACT

Provided are a user terminal having an enhanced privacy protection function, a method of using a lock function of the user terminal, and a computer-readable recording medium. The user terminal includes a lock function executing unit that receives an execution command from a service server to execute a lock function, a fingerprint input displaying unit that displays a fingerprint input requesting window when an operation command is input, a fingerprint sensor unit that receives fingerprint information, and a lock function releasing unit that releases the lock function when the fingerprint information input through the fingerprint sensor unit is identified with preregistered fingerprint information.

### CROSS-REFERENCE TO RELATED APPLICATION

This application claims priority to and the benefit of Korean Patent Application No. 2012-110164, filed on Oct. 10, 2012, the disclosure of which is incorporated herein by reference in its entirety.

### BACKGROUND

1. Field of the Invention

The present invention relates to a user terminal, a method of using a lock function of the same, and a computer-readable recording medium, and more particular, to a user terminal which has an enhanced privacy protection function, a method of using a lock function of the same, and a computer-readable recording medium.

2. Discussion of Related Art

In recent years, various additional functions utilizing personal information such as mobile banking have been provided through mobile communication terminals in addition to communication functions such as phone services or text message transmission services.

Thus, there is an urgent need for a lock device for the mobile communication terminal.

Most existing lock devices applied to the mobile communication terminals use typical methods using passwords.

For example, in a typical method, the lock device is applied to a phone function, an additional function, an international calling function, or the like, and a corresponding password should be input in order to use the corresponding function.

However, there are disadvantages in that the method is useless when the password is exposed, the password should be regularly changed in order to ensure stability, a user should remember the password, and the like.

Thus, in recent years, in order to supplement the above-described method and improve locking effects, a terminal in which a lock device using fingerprint recognition is mounted has been developed in earnest.

In order for such a fingerprint recognition apparatus to be mounted in a mobile communication terminal which is manufactured to be small, a size of a corresponding sensor should be minimized. In accordance with this need, a “sliding type” fingerprint recognition sensor that recognizes a fingerprint when a corresponding finger is swiped on a sensor which is provided in the form of a laterally long bar has been developed.

Meanwhile, as fingerprint recognition sensors are mounted on mobile communication terminals, efforts to graft other functions onto the fingerprint recognition sensor are being made.

### SUMMARY

The present invention is directed to a user terminal which remotely performs a lock function at the time of loss of the user terminal, a method of using the lock function of the user terminal, and a computer-readable recording medium.

According to an aspect of the present invention, there is provided a user terminal including: a lock function executing unit that receives an execution command from a service server to execute a lock function; a fingerprint input displaying unit that displays a fingerprint input requesting window when an operation command is input; a fingerprint sensor unit that receives fingerprint information; and a lock function releasing unit that releases the lock function when the fingerprint information input through the fingerprint sensor unit is identified with preregistered fingerprint information.

Here, the user terminal may further include a global positioning system (GPS) executing unit that receives an execution command from the service server to execute a GPS function so that location tracking is performed.

According to another aspect of the present invention, there is provided a method of using a lock function of a user terminal, including: receiving an execution command from a service server to execute a lock function; displaying a fingerprint input requesting window when an operation command is input; receiving fingerprint information; and releasing the lock function when the input fingerprint information is identified with preregistered fingerprint information.

Here, the method may further include receiving an execution command from the service server to execute a GPS function so that location tracking is performed.

According to still another aspect of the present invention, there is provided a computer-readable recording medium in which a program for executing a method of using a lock function of a user terminal is recorded.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 illustrates an example of a structure of a user terminal according to an embodiment of the present invention;

FIG. 2 illustrates an example of a fractional fingerprint image obtained by a sliding fingerprint sensor unit shown in FIG. 1;

FIG. 3 is a block diagram illustrating a configuration of a user terminal according to an embodiment of the present invention;

FIG. 4 illustrates an example of a process of executing and releasing a lock function of a user terminal according to an embodiment of the present invention; and

FIG. 5 is a flowchart illustrating a method of using a lock function of a user terminal according to an embodiment of the present invention.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Hereinafter, embodiments of the present invention will be described in detail with reference to the accompanying drawings.

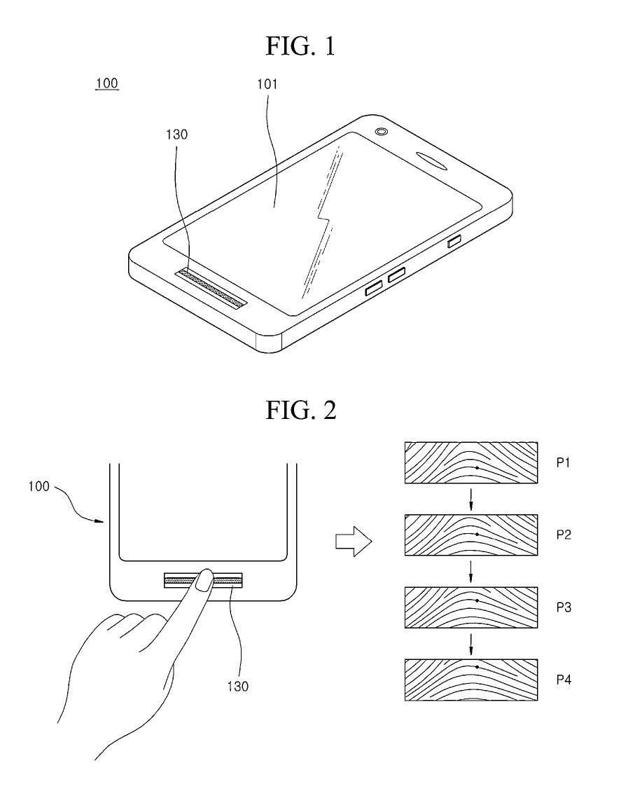

FIG. 1 illustrates an example of a structure of a user terminal according to an embodiment of the present invention.

Referring to FIG. 1, a user terminal 100 according to an embodiment of the present invention may include a fingerprint sensor unit 130 in at least a portion thereof.

In FIG. 1, a case in which the fingerprint sensor unit 130 is formed in a side edge of the user terminal 100 is shown, but the fingerprint sensor unit 130 can be formed in any position without departing from the scope of the present invention.

The user terminal 100 according to an embodiment of the present invention may be a digital device that performs a user's desired operation by performing predetermined data processing.

In addition, the user terminal 100 may include an input unit and a display unit 101, and provide a state with respect to an operation performed by a predetermined operation instruction of the user through the input unit to the user through the display unit 101.

In FIG. 1, an example in which the display unit 101 of the user terminal 100 is implemented in a touch screen method and the display unit itself simultaneously acts as the input unit is illustrated, but the input unit may be implemented in, for example, a keyboard or keypad method and provided separately from the display unit 101.

The user terminal 100 according to an embodiment of the present invention should be understood as an encompassing term including digital devices which include a memory means performed in a touch screen method and have a microprocessor mounted therein for computing power, such as tablet PCs, smart phones, PDAs, web pads, mobile phones, navigation systems, digital cameras, and the like.

In addition, the user terminal 100 according to another embodiment of the present invention should be understood as an encompassing term including devices in which a separate fingerprint recognition device is connected to a personal computer (PC), a workstation, or the like.

The fingerprint sensor unit 130 according to an embodiment of the present invention may be implemented as a sliding type. The sliding type fingerprint sensor unit 130 performs fingerprint recognition in such a manner that fragmentary fingerprint images are read by sensing a fingerprint of a finger which slidably moves and then the read fragmentary fingerprint images are matched to a single image to implement a complete fingerprint image.

FIG. 2 illustrates an example of fractional fingerprint images obtained by a sliding fingerprint sensor unit shown in FIG. 1.

For example, when a user slidably moves his or her thumb on the fingerprint sensor unit 130, partial fractional images P1 to P4 are consecutively obtained.

That is, fingerprint images of the user are sequentially obtained in a fractional but mutually consecutive manner.

The fractional fingerprint images read from the fingerprint sensor unit 130 are matched to a single fingerprint image.

According to an embodiment, the matched fingerprint image is compared with preregistered fingerprint image, and is used as a means for confirming the authenticity of the user.

That is, user authentication may be performed in such a manner that the registered fingerprint image of the user may be stored in a database (not shown) of the user terminal 100 and the corresponding fingerprint image obtained by the fingerprint sensor unit 130 may be compared with the registered fingerprint image stored in the database.

According to another embodiment, the matched fingerprint image may be compared with preregistered at least one fingerprint image, and act as an instruction for performing a specific operation.

For example, specific operations are matched with fingerprints of each finger of the user and stored, and when the matched fingerprint image obtained by the fingerprint sensor unit 130 identifies with a fingerprint image of a specific finger, a specific operation matched with this may be performed. This is called a “quick launching” function in the present specification.

For example, the user may perform setting in advance in such a manner that a first application is driven when a thumb fingerprint of a true user is recognized and a second application is driven when an index fingerprint of the user is recognized.

Thereafter, when the user slidably moves his or her thumb on the fingerprint sensor unit 130 and the matched fingerprint image obtained by the fingerprint sensor unit 130 identifies with preregistered thumb fingerprint image, an operation matched with this, that is, a driving operation of the first application, may be performed.

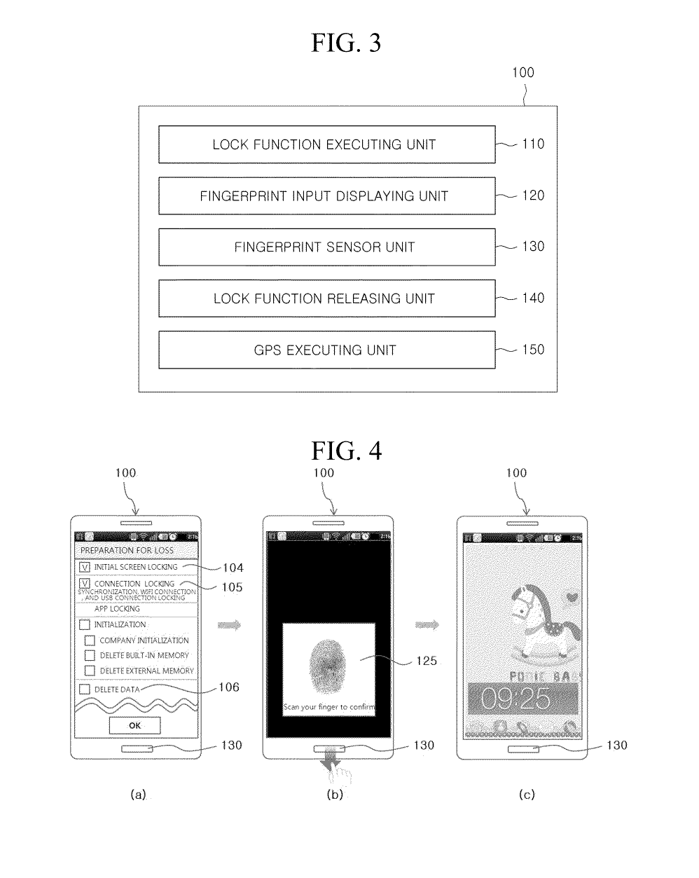

FIG. 3 is a block diagram illustrating a configuration of a user terminal according to an embodiment of the present invention, and FIG. 4 illustrates an example of a process of executing and releasing a lock function of a user terminal according to an embodiment of the present invention.

As shown in FIGS. 3 and 4, the user terminal 100 according to an embodiment of the present invention may include a lock function executing unit 110, a fingerprint input displaying unit 120, a fingerprint sensor unit 130, and a lock function releasing unit 140.

First, the lock function executing unit 110 may receive an execution command from a service server (not shown) to execute a lock function. The “lock function” in the present invention refers to a security function for preventing an unauthorized user to use a specific function, such as initial screen locking or connection locking.

Here, specific functions which are locked by execution of the lock function executing unit 110 may be determined in advance by the user terminal 100.

In (a) of FIG. 4, an example in which initial screen locking 104 and connection locking 105 are set in preparation for the loss of the user terminal 100 is shown, and in this case, when the lost user terminal 100 receives an execution command from a service server, an initial screen on which locking has been set and connection such as WiFi connection are turned to a locked state, and cannot be used unless they are released.

Data deletion 106 may include a delete selection with respect to an address book, call history, multimedia, messages, e-mails, and the like.

The service server may be a mobile communication company server, and transmit an execution command to the lock function executing unit 110 of the lost user terminal 100 so as to execute a lock function set in advance when receiving information about report of the loss of the user terminal 100.

The information about the report of the loss of the user terminal 100 may be transmitted to the service server through phones, the Internet, or the like, and may be transmitted to the service server, for example, by transmitting a text message through a specific command or making a call through a specific password.

Thus, when once the lock function is executed and then a true user of the user terminal 100 or a finder thereof who is not the true user wishes to use the user terminal 100, the lock function can be released only through fingerprint authentication.

For this, when an operation command such as touching the display unit 101 of the user terminal 100 whose lock function has been executed, pushing the fingerprint sensor unit 130, or the like is input, the fingerprint input displaying unit 120 may display a fingerprint input requesting window 125 as shown in (b) of FIG. 4.

Next, the fingerprint sensor unit 130 may receive fingerprint information.

Detailed descriptions of fingerprint sensing have been described above and thus will be omitted here.

The lock function releasing unit 140 may release the lock function when the fingerprint information input through the fingerprint sensor unit 130 is identified with preregistered fingerprint information, and may be turned to a general use state as shown in (c) of FIG. 4 when the lock function is released.

Meanwhile, the user terminal 100 may further include a global positioning system (GPS) executing unit 150.

The GPS executing unit 150 may receive an execution command from the service server to execute a GPS function so that location tracking is performed.

In this manner, the user may set the lock function in the user terminal 100 in preparation for the loss of the user terminal 100 so that the lock function is executed at the time of the loss of the user terminal 100, and therefore it is possible to prevent information leakage at the time of the loss of the user terminal 100.

In addition, the lock function of the user terminal whose lock function has been executed can be released only when a true user is authenticated through fingerprint information, thereby enhancing a privacy protection function of the true user.

In addition, the GPS function of the user terminal 100 may be executed, and therefore location tracking of the lost user terminal 100 may be performed.

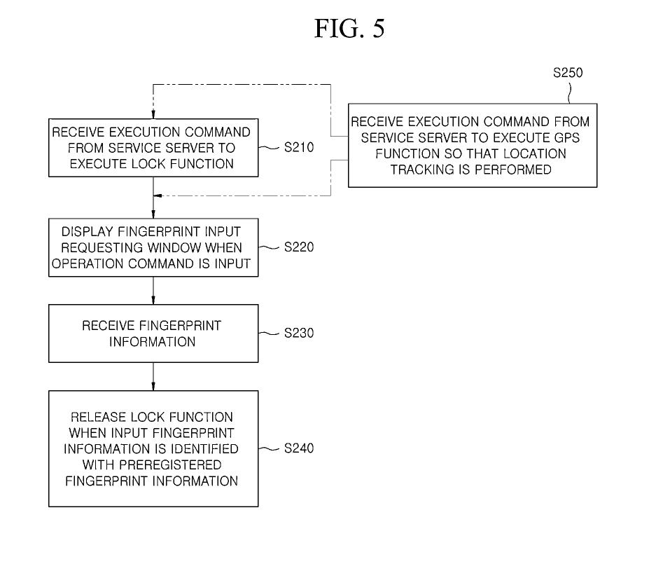

FIG. 5 is a flowchart illustrating a method of using a lock function of a user terminal according to an embodiment of the present invention.

As shown in FIG. 5, in operation S210, an execution command is received from a service server to execute a lock function.

Here, specific functions to be locked may be set in advance in the user terminal.

The service server may be a mobile communication company server, and when receiving information about report of the loss of the user terminal 100, the service server may transmit an execution command to the lost user terminal so that the lock function set in advance in the lost user terminal is executed.

The information about the report of the loss of the user terminal may be transmitted to the service server through phones, the Internet, or the like, and may be transmitted to the service server, for example, by transmitting a text message through a specific command or making a call through a specific password.

Next, in operation S220, when an operation command is input, a fingerprint input requesting window is displayed.

Here, as an example of the operation command for enabling the fingerprint input requesting window to be displayed, touching the display unit of the user terminal, pushing the fingerprint sensor unit, or the like may be given.

Next, in operation S230, fingerprint information is received, and in operation S240, the lock function is released when the input fingerprint information is identified with preregistered fingerprint information.

In addition, in operation S250, the execution command is received from the service server, and a GPS function is executed so that location tracking is performed.

Operation S250 of executing the GPS function may be performed before or after operation S210 of receiving the execution command from the service server to execute the lock function, or simultaneously with operation S210.

In this manner, the user may set the lock function in the user terminal in preparation for the loss of the user terminal so that the lock function is executed at the time of the loss of the user terminal, and therefore it is possible to prevent information leakage at the time of the loss of the user terminal.

In addition, the lock function of the user terminal whose lock function has been executed can be released only when a true user is authenticated through fingerprint information, thereby enhancing a privacy protection function of the true user.

In addition, the GPS function of the user terminal may be executed, and therefore location tracking of the lost user terminal may be performed.

The embodiments of the present invention may be implemented in the form of software readable by various computer means and recorded in a computer-readable recording medium. The computer-readable recording medium may separately include program commands, local data files, local data structures, etc. or include a combination of them. The medium may be specially designed and configured for the present invention, or known and available to those of ordinary skill in the field of computer software. Examples of the computer-readable recording medium include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers. Such a hardware apparatus may be configured to operate in one or more software modules, or vice versa in order to perform the operation of the present invention.

According to the present invention, the user may set the lock function in the user terminal in preparation for the loss of the user terminal so that it is possible to prevent information leakage at the time of the loss of the user terminal. The lock function of the user terminal whose lock function has been executed can be released only when a true user is authenticated through fingerprint information, thereby enhancing a privacy protection function of the true user.

According to the present invention, the GPS function of the user terminal may be executed at the time of the loss of the user terminal, and therefore location tracking of the lost user terminal may be performed.

The effects of the present invention are not limited to the above described effects but it should be understood that all effects which can be induced from the configuration of the invention described in the detailed description or claim of the present invention are included.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A user terminal comprising:
a lock function executing unit that receives an execution command from a service server to execute a lock function;
a fingerprint input displaying unit that displays a fingerprint input requesting window when an operation command is input;
a fingerprint sensor unit that receives fingerprint information; and
a lock function releasing unit that releases the lock function when the fingerprint information input through the fingerprint sensor unit is identified with preregistered fingerprint information.

2. The user terminal of claim 1, further comprising:
a global positioning system (GPS) executing unit that receives an execution command from the service server to execute a GPS function so that location tracking is performed.

3. A method of using a lock function of a user terminal, comprising:
receiving an execution command from a service server to execute a lock function;
displaying a fingerprint input requesting window when an operation command is input;
receiving fingerprint information; and
releasing the lock function when the input fingerprint information is identified with preregistered fingerprint information.

4. The method of claim 3, further comprising:
receiving an execution command from the service server to execute a GPS function so that location tracking is performed.

5. A computer-readable recording medium in which a program for executing the method according to claim 3 is recorded.

6. A computer-readable recording medium in which a program for executing the method according to claim 4 is recorded.
